(19) United States
(12) Patent Application Publication
(10) Pub. No.: US 2025/0192665 A1
(43) Pub. Date: Jun. 12, 2025

(54) POWER CONVERTER

(71) Applicant: FUJI ELECTRIC CO., LTD., Kawasaki-shi (JP)

(72) Inventor: Sachio TAKANO, Tokyo (JP)

(73) Assignee: FUJI ELECTRIC CO., LTD., Kawasaki-shi (JP)

(21) Appl. No.: 19/060,244

(22) Filed: Feb. 21, 2025

Related U.S. Application Data
(63) Continuation of application No. PCT/JP2023/043706, filed on Dec. 6, 2023.

(30) Foreign Application Priority Data
Feb. 16, 2023 (JP) 2023-022160

(51) Int. Cl. H02M 1/00; H02M 1/12; H02M 1/44

(52) U.S. Cl. CPC H02M 1/0093; H02M 1/0009; H02M 1/126; H02M 1/44

(57) ABSTRACT

A power converter that supplies power to a power system via a filter that includes a reactor and a capacitor, the power converter includes: a first subtraction unit configured to calculate a first difference between a measured value of a first current flowing through the reactor and a current command value of the first current for causing a voltage at the capacitor to reach a target voltage; an addition unit configured to add a value corresponding to the first difference and a voltage command value of the voltage at the capacitor together; and a voltage output unit configured to output, to the filter, an output voltage corresponding to a result of addition of the addition unit.

### CROSS-REFERENCE TO RELATED APPLICATIONS

This is a continuation application of International Patent Application No. PCT/JP2023/043706 filed Dec. 6, 2023, which claims the benefit of priority to Japanese Patent Application No. 2023-022160 filed Feb. 16, 2023, the entire contents of each of which are hereby incorporated herein by reference.

### BACKGROUND

### Technical Field

The present disclosure relates to a power converter.

### Description of the Related Art

A synchronous generator contributes to maintaining the frequency of a power system by the inertia of a rotor. In recent years, known is a pseudo-synchronous generator that controls an output from an inverter while performing processing of simulating a rotor included in the synchronous generator (for example, Japanese Patent No. JP7023430).

A pseudo-synchronous generator is generally provided to a power system via a filter for removing harmonic components of a current. In such a case, interposing the filter may cause the voltage actually outputted to the power system to significantly deviate from a voltage command value in some cases.

The pseudo-synchronous generator described in Japanese Patent No. JP 7023430 does not disclose measures to suppress such deviation from the voltage command value.

The present disclosure is directed to provision of a power converter capable of preventing the voltage actually outputted to a power system from deviating from a voltage command value.

### SUMMARY

An aspect of the present disclosure is a power converter that supplies power to a power system via a filter that includes a reactor and a capacitor, the power converter comprising: a processor, and a non-transitory storage medium having program instructions stored thereon, execution of which by the processor causes the power converter to provide functions of: a first subtraction unit configured to calculate a first difference between a measured value of a first current flowing through the reactor and a current command value of the first current for causing a voltage at the capacitor to reach a target voltage; an addition unit configured to add a value corresponding to the first difference and a voltage command value of the voltage at the capacitor together; and a voltage output unit configured to output, to the filter, an output voltage corresponding to a result of addition of the addition unit.

Another aspect of the present disclosure is a power converter that supplies power to a power system via a filter that includes a reactor and a capacitor, the power converter comprising: a processor, and a non-transitory storage medium having program instructions stored thereon, execution of which by the processor causes the power converter to provide functions of: a first subtraction unit configured to calculate a difference between a voltage command value of a voltage at the capacitor and a measured value of the voltage at the capacitor; a current command value output unit configured to output a current command value of a current flowing through the reactor for causing the voltage at the capacitor to reach a target voltage, based on a target value of a first current flowing through the capacitor when the voltage at the capacitor reaches the voltage command value, a measured value of a second current flowing from a node at which the reactor and the capacitor are connected, to the power system, and a first value corresponding to a result of subtraction of the first subtraction unit; a second subtraction unit configured to calculate a difference between the current command value and a measured value of the current flowing through the reactor; an addition unit configured to add a second value corresponding to a result of subtraction of the second subtraction unit and the measured value of the voltage at the capacitor together; and a voltage output unit configured to output, to the filter, an output voltage corresponding to a result of addition of the addition unit.

Other features of the present disclosure will be made clear from what is described in this description.

According to the present disclosure, it is possible to provide a power supply device capable of preventing the voltage actually outputted to a power system from deviating from a voltage command value.

### BRIEF DESCRIPTION OF DRAWINGS

FIG. 1 is a diagram illustrating an example of a power system 1 provided with a power converter 2 (5 to 7).

FIG. 2 is a diagram illustrating an example of functional blocks of a control device 20 in a general power converter 2.

FIG. 3 is a diagram illustrating an example of functional blocks of a control device 50 in a power converter 5 of an embodiment.

FIG. 4 is a diagram illustrating an example of functional blocks of a control device 60 in a power converter 6 of an embodiment.

FIG. 5 is a diagram illustrating an example of functional blocks of a control device 70 in a power converter 7 of an embodiment.

FIG. 6A is a diagram illustrating a simulation results with respect to a power converter 6 and a power converter 7.

FIG. 6B is a diagram illustrating a simulation results with respect to a power converter 6 and a power converter 7.

FIG. 6C is a diagram illustrating a simulation results with respect to a power converter 6 and a power converter 7.

### DESCRIPTION OF EMBODIMENTS

### {General Power Converter}

Before description of a power converter of an embodiment, first, a general power converter 2 will be described to clarify an issue of the general power converter 2.

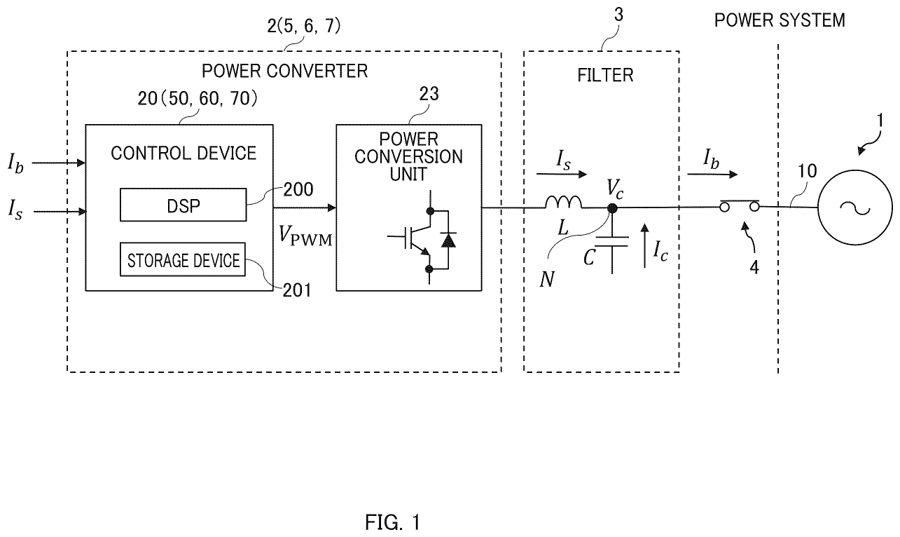

FIG. 1 is a diagram illustrating an example of the general power converter 2 provided to a power system 1. The power system is a system that supplies an alternating-current (AC) power generated at a power station to facilities of a customer via a distribution line 10.

The power converter 2 is provided to the power system 1 via a filter 3. A switch 4 is provided between the filter 3 and the power system 1. The filter 3, the power converter 2, and the switch 4 will be described below in this order.

### <<Filter 3>>

The filter 3 is provided to remove harmonic components of a current flowing from the power converter 2 to the power system 1. A current Is outputted from the power converter 2 is inputted to the filter 3. The filter 3 then outputs, to the power system 1, a current Ib obtained by removing harmonic components from the current Is.

The filter 3 includes a reactor L and a capacitor C. The reactor L has one end connected to the output of the power converter 2, and the other end connected to the power system 1. The capacitor C has one end connected between the reactor L and the power system 1.

In the following description, a point at which the one end of the capacitor C is connected between the reactor L and the power system 1 is referred to as “node N”.

### <<Power Converter 2>>

The power converter 2 is a so-called pseudo-synchronous generator that simulates a synchronous generator including a rotor. The power converter 2 includes a control device 20 and a power conversion unit 23. The following describes them individually.

### <Control Device 20>

In the following, a hardware configuration of the control device 20 will be described first, and then functional blocks of the control device 20 will be described.

### Hardware Configuration of Control Device 20

The control device 20 includes a digital signal processor (DSP) 200 and a storage device 201 (FIG. 1).

### (DSP 200)

The DSP 200 executes a predetermined program stored in the storage device 201, to thereby implement various functions of the control device 20.

### (Storage Device 201)

The storage device 201 includes a non-temporary (for example, nonvolatile) storage device that stores various types of data to be executed or processed by the DSP 200.

The storage device 201 further includes, for example, a random-access memory (RAM) and/or the like and is used as a temporary memory area for various programs, data, and the like.

### Functional Blocks of Control Device 20

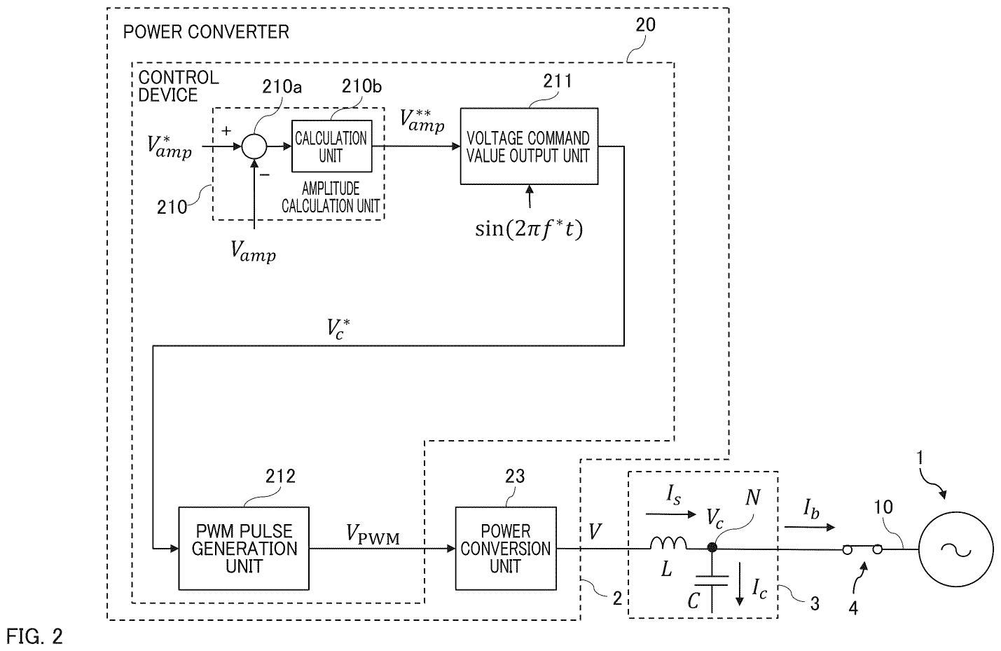

FIG. 2 is a diagram illustrating the functional blocks of the control device 20. The control device 20 includes an amplitude calculation unit 210, a voltage command value output unit 211, and a PWM pulse generation unit 212. The following describes them individually.

### (Amplitude Calculation Unit 210)

The amplitude calculation unit 210 calculates an amplitude Vₐₘₚ** of a target voltage at the node N. As the amplitude calculation unit 210, a so-called automatic voltage regulator can be used.

Specifically, the amplitude Vₐₘₚ** is calculated based on the difference between a target value Vₐₘₚ* Of the amplitude of the target voltage at the node N and an actual measured value Vₐₘₚ of the amplitude of the voltage at the capacitor.

The amplitude calculation unit 210 includes a subtraction unit 210a and a calculation unit 210b. The subtraction unit 210a calculates the difference between the target value Vₐₘₚ* of the amplitude of the target voltage at the node N and the actual measured value Vₐₘₚ of the amplitude of the voltage at the capacitor. The calculation unit 210b calculates the amplitude Vₐₘₚ** of the target voltage such that the result of the subtraction of the subtraction unit 210a approaches 0 (zero).

### (Voltage Command Value Output Unit 211)

The voltage command value output unit 211 outputs a voltage command value V_{C}*, based on the amplitude Vₐₘₚ** Of the target voltage of the capacitor C, a frequency f*, and a phase 2πf*t.

Specifically, the voltage command value V_{C}* is calculated according to the following expression:

$${V}_{C}^{⋆} = {V}_{amp}^{⋆ ⋆} sin ( 2 π f \text{?} t ) \qquad [ Math . 1 ]$$

$$\text{?} \text{indicates text missing or illegible when filed}$$

where f* is a command value of a frequency of the voltage V_{C} at the node N, and t is time.

### (PWM Pulse Generation Unit 212)

The PWM pulse generation unit 212 detects a node between a carrier wave and a sine wave serving as a fundamental wave, the carrier wave being implemented by a triangular wave, for example. This causes the PWM pulse generation unit 212 to determine the duty ratio of a PWM pulse and generate a PWM pulse signal V_{PWM} having the determined duty ratio.

The PWM pulse V_{PWM} is outputted to the power conversion unit 23, to thereby drive an inverter circuit of the power conversion unit 23.

### <Power Conversion Unit 23>

The power conversion unit 23 includes a direct-current (DC) power supply and the inverter circuit (not illustrated) that includes a plurality of switching elements. The inverter circuit converts a direct-current (DC) voltage from the DC power supply into an alternating-current (AC) voltage, to output the AC voltage to the power system 1 via the filter 3.

In this event, the inverter circuit outputs a voltage generated based on the PWM pulse signal V_{PWM}, which is an output from the PWM pulse generation unit 212. The voltage outputted here corresponds to a voltage command value V at the node N.

### <<Switch 4>>

The switch 4 is connected between the power system 1 and the power converter 2. The switch 4 is a breaker, for example.

When the power system 1 is in a normal state, the switch is on, and the power converter 2 can exchange power with the power system 1. When an abnormality such as a failure in the power system 1 occurs, the switch is turned off, and the power converter 2 is disconnected from the power system 1.

The general power converter 2 controls the output voltage V of the power conversion unit 23. However, since the power converter 2 is provided to the power system via the filter, the voltage V_{C} at the node N deviates from a target value. Hence, the power converter 2 may not be able to exchange desired power with the power system 1 in some cases.

Power converters 5 to 7 of embodiments described below are each a device capable of suppressing deviation of the voltage at the node N from the voltage command value.

### First Embodiment

### <<Power Converter 5>>

As described above, the general power converter 2 has an issue that the voltage at the node N deviates from the voltage command value. The power converter 5 according to an embodiment of the present application is a device capable of suppressing deviation of the voltage at the node N from the voltage command value.

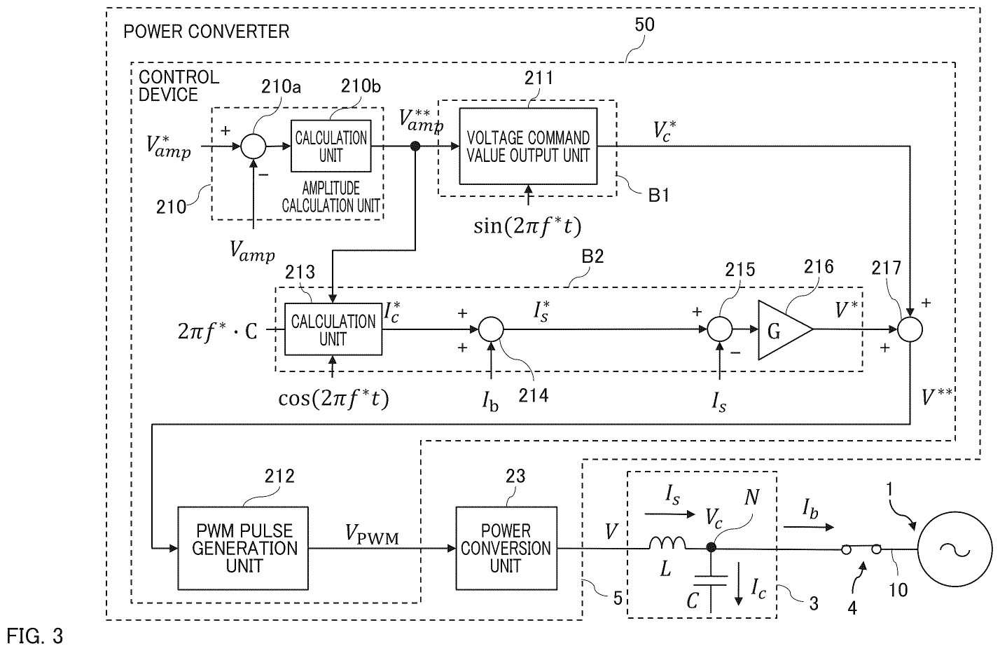

FIG. 3 is a diagram illustrating an example of the power converter 5 of an embodiment of the present application and is particularly the diagram illustrating an example of functional blocks of a control device 50 therein.

The control device 50 includes the amplitude calculation unit 210, a block B1, a block B2, an addition unit 217, and the PWM pulse generation unit 212, and details thereof will be described below.

Here, the block B1 is a block that generates a signal to control the voltage outputted from the power converter 5. The block B2 is a block that generates a signal to control the current outputted from the power converter 5.

In an embodiment of the present application, the block B1 includes the voltage command value output unit 211 of the general power converter 2 described above. Hence, the control device 50 is different from the control device 20 of the general power converter 2 in that the control device 50 further includes the block B2.

By further including the block B2, the power converter 5 can suppress deviation of the voltage at the node N. Details will be described below.

Note that the power conversion unit 23 and the filter 3 are the same as those described in the general power converter 2, and thus description thereof will be omitted below.

### <Control Device 50>

The control device 50 includes the amplitude calculation unit 210, the block B1, the block B2, the addition unit 217, and the PWM pulse generation unit 212 (FIG. 3).

The amplitude calculation unit 210 and the PWM pulse generation unit 212 are the same as those described in the general power converter 2, and thus description thereof will be omitted. Further, in the block B1, the voltage command value output unit 211 constituting the block B1 is the same as that described in the general power converter 2, and thus description thereof will be omitted.

### Block B2

The block B2 includes a calculation unit 213, a current command value output unit 214, a subtraction unit 215, and an output unit 216. The following describes them individually.

### (Calculation Unit 213)

The calculation unit 213 calculates a target value I_{C}* of the current I_{C} flowing through the capacitor C. The target value I_{C}* is calculated based on the amplitude Vₐₘₚ**, the frequency f′, the phase 2πf*t of a result of differentiation of the target voltage, and a capacitance C of the capacitor C.

Specifically, the target value I_{C}* of the current I_{C} is calculated according to the following expression:

$${I}_{C}^{⋆} = C \frac{{dV}_{C}^{⋆}}{dt} = 2 π f \text{?} {CV}_{amp}^{⋆ ⋆} cos ( 2 π f \text{?} t ) \qquad [ Math . 2 ]$$

$$\text{?} \text{indicates text missing or illegible when filed}$$

where, the mathematical expression 1 is used for the second equal sign.

### (Current Command Value Output Unit 214)

The current command value output unit 214 outputs a current command value Iₛ* of the current flowing through the reactor L. The current command value Iₛ* corresponds to the current flowing through the reactor L when the voltage V_{C} at the node N reaches the voltage command value V_{C}*.

The current command value Iₛ* is outputted, based on the target value I_{C}* of the current I_{c} and the measured value I_{b} of the current flowing from the node N, at which the reactor L and the capacitor C are connected, to the power system.

The current command value Iₛ* is specifically an added value of the measured value I_{b} of the current and the target value I_{C}* of the current.

### (Subtraction Unit 215)

The subtraction unit 215 calculates the difference between the measured value Iₛ of the current flowing through the reactor L and the current command value Iₛ* outputted from the current command value output unit 214.

### (Output Unit 216)

The output unit 216 multiplies the result of the subtraction of the subtraction unit 215 by a predetermined constant G, to thereby output an output value V*.

Specifically, the output value V* is calculated according to the following expression:

$${V}^{⋆} = G ( {I}_{C}^{⋆} + I \text{?} - {I}_{s} ) . \qquad [ Math . 3 ]$$

$$\text{?} \text{indicates text missing or illegible when filed}$$

### (Addition Unit 217)

The addition unit 217 adds together a value corresponding to the difference calculated by the subtraction unit 215 and the voltage command value V_{C}* of the voltage at the capacitor C outputted from the voltage command value output unit 211.

Here, it is assumed that the “value corresponding to the difference calculated by the subtraction unit 215” is the output value V* from the output unit 216 expressed by the mathematical expression 3 in an embodiment of the present application.

A result V** of the addition or the addition unit 217 is obtained by adding V_{C}* to V* of the mathematical expression 3 and given by the following expression.

$${V}^{⋆} = G ( {I}_{C}^{⋆} + I \text{?} - {I}_{s} ) + {V}_{C}^{⋆} \qquad [ Math . 4 ]$$

$$\text{?} \text{indicates text missing or illegible when filed}$$

The result V** of the addition (mathematical expression 3) of the addition unit 217 is inputted to the PWM pulse generation unit 212. Processing of the control device 50 subsequent to the above is the same as the processing of the control device 20 described above.

According to the power converter 5 described above, it is possible to control the voltage V_{C} at the node N so as to reach the voltage command value V_{C}*.

This is because the block B2 controls the current Iₛ flowing through the reactor L so as to reach the current command value Iₛ*. In response to the current Iₛ flowing through the reactor L reaching the current command value Iₛ*, the voltage V_{C} at the node N reaches the voltage command value V_{C}*.

With the voltage V_{C} at the node N reaching the voltage command value V_{C}*, the voltage actually outputted to the power system 1 reaches the voltage command value V_{C}*.

Although it is assumed that the amplitude calculation unit 210 is included in the control device 50 of an embodiment of the present application, this is a given configuration, and the amplitude calculation unit 210 may not be included in the control device 50.

### <<Correspondence Relationships>>

Here, correspondence relationships of the power converter 5 according to an embodiment of the present application will be summarized. First, it should be noted that, in the power converter 5 of an embodiment of the present application, the voltage command value V_{C}* is added to the output value V* outputted from the output unit 216, in the addition unit 217.

In contrast thereto, in the power converters 6 and 7 of other embodiments, in the addition unit 217, the measured value V_{C} of the voltage at the capacitor C is added to the output value V* outputted from the output unit 216, which will be described below in detail.

In such a power converter in which the voltage command value V_{c}* is added in the addition unit 217 as in an embodiment of the present application, it is assumed to follow the correspondence relationships below.

The subtraction unit 215 corresponds to a “first subtraction unit”. The current flowing through the reactor L corresponds to a “first current”. The current I_{C} flowing through the capacitor C corresponds to a “second current”. The current flowing from the node N to the power system corresponds to a “third current”.

The difference between the measured value Iₛ of the current flowing through the reactor L and the current command value Iₛ* of the current for causing the voltage at the capacitor C to reach the target voltage corresponds to a “first difference”. The difference between the target value Vₐₘₚ* of the amplitude of the target voltage at the node N and the actual measured value Vₐₘₚ of the amplitude of the voltage at the capacitor corresponds to a “second difference”. The output value V* of the output unit 216 corresponds to a “first value”.

A combination of the PWM pulse generation unit 212 and the power conversion unit 23 corresponds to a “voltage output unit”. In other words, the voltage output unit outputs, to the filter 3, an output voltage corresponding to the result of the addition of the addition unit 217.

### Second Embodiment

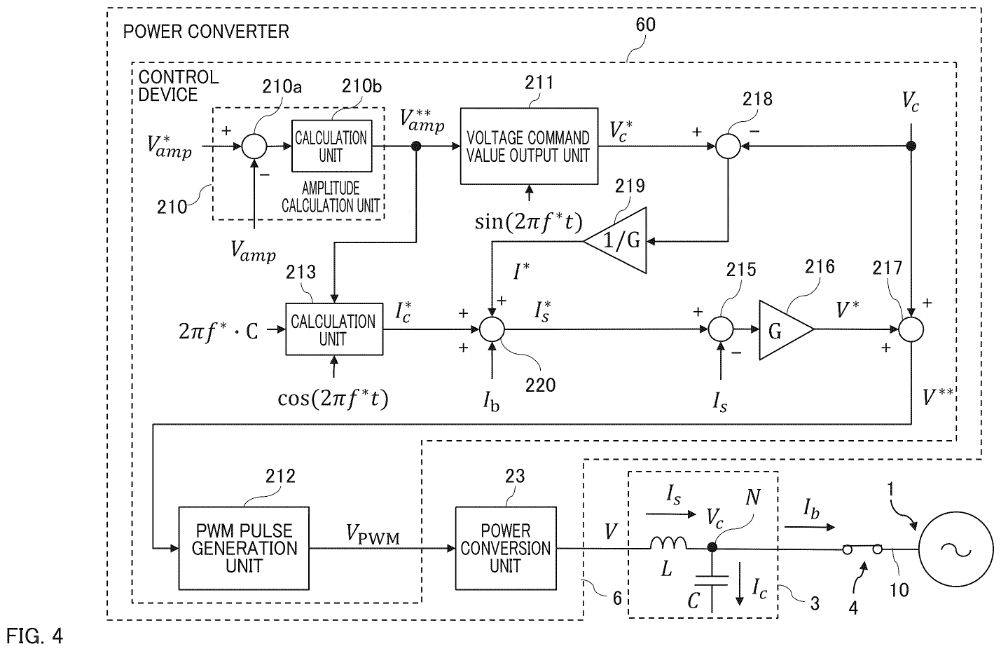

FIG. 4 is a diagram illustrating an example of the power converter 6 of an embodiment of the present application and is particularly the diagram illustrating an example of functional blocks of a control device 60 therein.

Although the functional blocks of the control device 60 are different from the functional blocks of the control device 50 of the first embodiment, the control device 60 outputs the same PWM pulse signal as in the control device 50 if the power system 1 is in the same state. In other words, the control device 60 is a device equivalent to the control device 50.

The control device 60 further includes a subtraction unit 218 and an output unit 219, as compared to the control device 50 of the first embodiment. The control device 60 is different therefrom in the configuration of the current command value output unit 220. The control device 60 is different therefrom in the signal inputted to the addition unit 217.

### (Subtraction Unit 218)

The subtraction unit 218 calculates the difference between the voltage command value V_{C}* of the voltage at the capacitor C and the measured value V_{C} of the voltage at the capacitor C.

### (Output Unit 219)

The output unit 219 multiplies the result of the subtraction of the subtraction unit 218 by the reciprocal of the predetermined constant G, to thereby output an output value I*. Here, the constant G is a constant by which the result of the subtraction of the subtraction unit 215 is multiplied in the output unit 216.

### (Current Command Value Output Unit 220)

The current command value output unit 220 outputs the current command value Iₛ* of the current flowing in the reactor L. The current command value Iₛ* corresponds to the current flowing through the reactor L for causing the voltage V_{C} at the capacitor C to reach the target voltage V_{C}*.

The current command value Iₛ* is outputted based on the target value I_{C}* of the current I_{C}, the measured value I_{b} of the current, and a value corresponding to the result of the subtraction of the subtraction unit 218.

Here, the current I_{C} is the current flowing through the capacitor C when the voltage V_{C} at the capacitor C reaches the voltage command value V_{C}*. The measured value I_{b} of the current is a measured value of the current flowing from the node N, at which the reactor L and the capacitor C are connected, to the power system 1. The “value corresponding to the result of the subtraction of the subtraction unit 218” is the output value I* from the output unit 219 in an embodiment of the present application.

The current command value Iₛ* is specifically an added value of the measured value I_{b} of the current, the target value I_{C}* of the current I_{C}, and the output value I*.

### (Addition Unit 217)

In an embodiment of the present application, the addition unit 217 adds together a value corresponding to the result of the subtraction of the subtraction unit 215 and the measured value V_{C} of the voltage at the capacitor C.

Here, the “value corresponding to the result of the subtraction of the subtraction unit 215” is the output value V* from the output unit 216 in an embodiment of the present application.

Specifically, the output value V* is given by the following expression:

$${V}^{⋆} = G ( {I}_{C}^{⋆} + \frac{{V}_{C}^{⋆} - {V}_{C}}{G} + {I}_{b} - {I}_{s} ) . \qquad [ Math . 5 ]$$

Accordingly, the result V** of the addition of the addition unit 217 is obtained by adding V_{C} to V* of the mathematical expression 5 and given by the following expression:

$${V}^{⋆ ⋆} = G ( {I}_{C}^{⋆} + {I}_{b} - {I}_{s} ) + {V}_{C}^{⋆} . \qquad [ Math . 6 ]$$

The addition result V** in an embodiment of the present application is equal to the addition result V** in the first embodiment (mathematical expression 4). In other words, it is shown that the control device 60 is equivalent to the control device 50 of the first embodiment.

The addition result V** (mathematical expression 5) of the addition unit 217 is inputted to the PWM pulse generation unit 212. Processing of the control device 60 subsequent to the above is the same as the processing of the control device 50 described above.

According to the power converter 6 described above, as in the power converter 5, it is possible to control the voltage V_{C} at the node N so as to reach the voltage command value V_{C}*.

Furthermore, the control device 60 of an embodiment of the present application receives the measured value V_{C} of the voltage at the capacitor C. This indicates that the voltage command value V is outputted after the measured value V_{C} is fed back, in the power converter 6 of an embodiment of the present application.

Note that, in an embodiment of the present application, the constant (G) by which an input value is multiplied in the output unit 216 and the constant (1/G) by which an input value is multiplied in the output unit 219 have a relationship of being reciprocals of each other. With such a relationship, the control device 60 results in being equivalent to the control device 50.

However, the relationship between the constant by which the input value is multiplied in the output unit 216 and the constant by which the input value is multiplied in the output unit 219 is not limited thereto, and any preferable value may be set appropriately.

### <<Correspondence Relationships>>

Here, correspondence relationships of the power converter 6 according to an embodiment of the present application will be summarized. First, it should be noted that, in the power converter 6 according to an embodiment of the present application, the measured value V_{C} of the voltage at the capacitor C is added to the output value V* from the output unit 216, in the addition unit 217.

In contrast thereto, as described above, in the power converter 5 of the first embodiment, the voltage command value V_{C}* is added to the output value V* from the output unit 216, in the addition unit 217 (FIG. 3).

In such a power converter in which the measured value V_{C} of the voltage at the capacitor C is added in the addition unit 217 as in an embodiment of the present application, it is assumed to follow the correspondence relationships below.

The subtraction unit 215 corresponds to a “second subtraction unit”. The subtraction unit 218 corresponds to a “first subtraction unit”. The output unit 219 corresponds to a “first output unit”. The output unit 216 corresponds to a “second output unit”.

The current I_{C} corresponds to a “first current”. The current I_{b} flowing from the node N, at which the reactor L and the capacitor C are connected, to the power system 1 corresponds to a “second current”. The current Iₛ flowing through the reactor L corresponds to a “third current”.

The “value corresponding to the result of the subtraction of the subtraction unit 218” corresponds to a “first value”. The “value corresponding to the result of the subtraction of the subtraction unit 215” corresponds to a “second value”.

Note that a third embodiment, which will be described below, has the same correspondence relationships as those in an embodiment of the present application.

### Third Embodiment

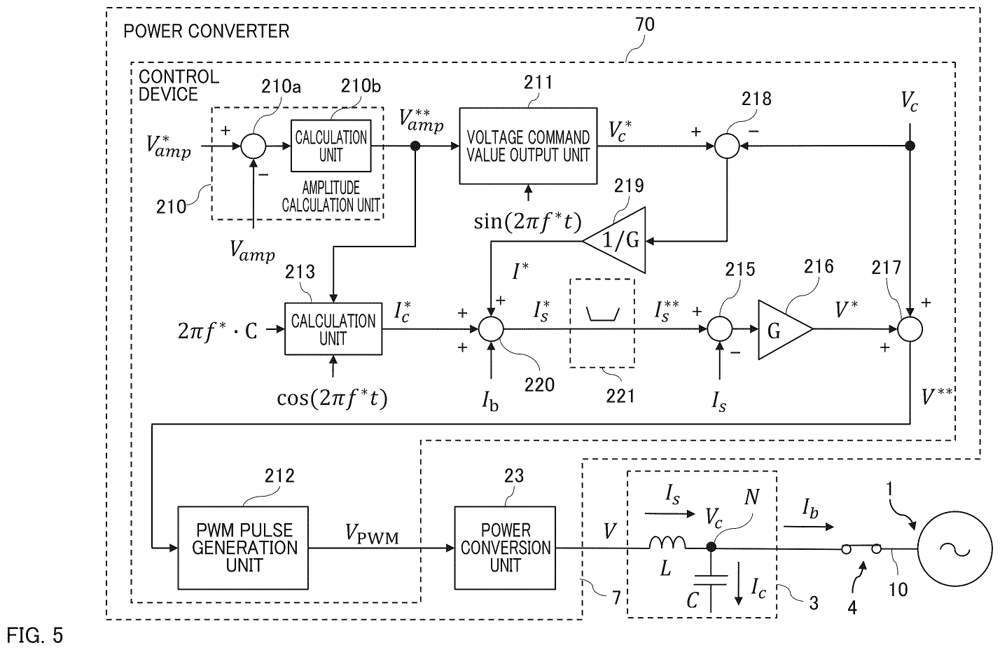

FIG. 5 is a diagram illustrating an example of the power converter 7 of an embodiment of the present application and is particularly the diagram illustrating an example of functional blocks of a control device 70 therein. The power converter 7 of an embodiment of the present application is a device capable of suppressing occurrence of an overcurrent.

The power converter 7 is different from the second embodiment in that the control device 70 further includes a restriction unit 221. The configuration other than this is similar to or the same as the second embodiment, and thus description thereof is omitted. Note that the power converter 7 of an embodiment of the present application also has the same correspondence relationships as those in the power converter 6 of the second embodiment.

### (Restriction Unit 221)

The restriction unit 221 restricts the current command value Iₛ* outputted from the current command value output unit 220 within a predetermined range, and outputs a restricted current command value Iₛ** to the subtraction unit 215.

Here, “within a predetermined range” may be a predetermined range within the range of the rated current of the power converter 7.

According to the power converter 7 described above, as in the power converter 6, it is possible to control the voltage V_{C} at the node N so as to reach the voltage command value V_{C}*, to thereby suppress occurrence of an overcurrent.

### <Results of Numerical Simulation>

Results of a numerical simulation assuming the power converter 7 of an embodiment of the present application and the power converter 6 of the second embodiment will be described.

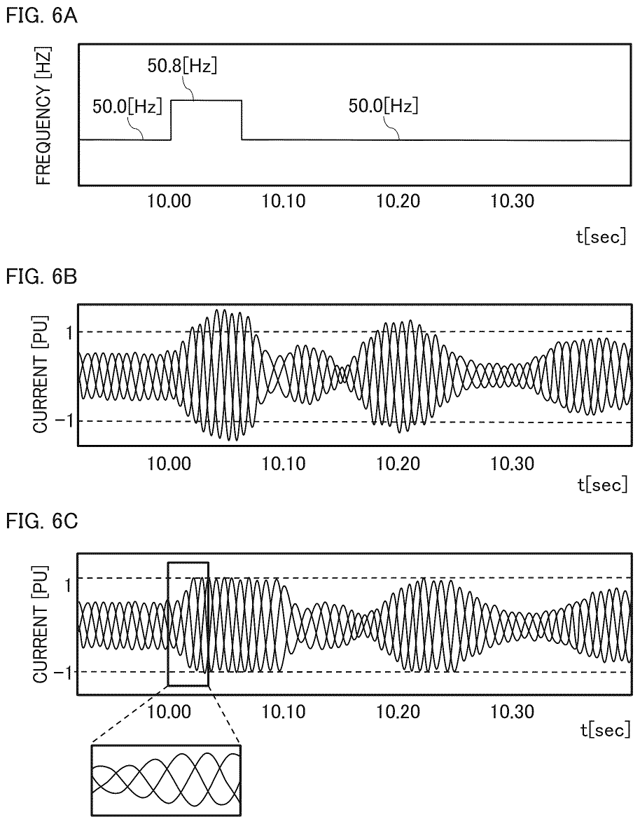

FIGS. 6A to 6C are diagrams illustrating simulation results assuming the power converters 6 and 7. In these drawings, FIG. 6A illustrates frequencies on a time series assumed in the power system 1, FIG. 6B illustrates a calculation result of the output current of the power converter 6 in the second embodiment, and FIG. 6C illustrates a calculation result of the output current of the power converter 7 in an embodiment of the present application.

In this calculation, step-shaped frequency variations are assumed (FIG. 6A). Before time t=10.0 [s] and after time t=10.06 [s], 50 [Hz] is assumed as the frequency in a normal state. Between time t=10.00 [s] and time t=10.06 [s], 50.8 [Hz] is assumed.

In FIGS. 6B and 6C, the vertical axis represents output current and it is normalized such that the rated current of the power converters 6 and 7 corresponds to 1. These diagrams illustrate respective AC currents of the three phases.

From these results, it can be seen that the output current varies without exceeding the rated current after the occurrence of the frequency variations in the power system 1, according to the power converter 7 of an embodiment of the present application. Hence, according to the power converter 7 of an embodiment of the present application, it is possible to prevent occurrence of an overcurrent.

### SUMMARY

As described above, the power converter 5 of the first embodiment is a power converter that supplies power to the power system 1 via the filter 3 that includes the reactor L and the capacitor C, the power converter 5 including: the subtraction unit 215 configured to calculate the first difference between the measured value of the first current flowing through the reactor L and the current command value of the first current for causing the voltage at the capacitor C to reach the target voltage; the addition unit 217 configured to add the value corresponding to the first difference and the voltage command value of the voltage at the capacitor C together; and the voltage output unit configured to output, to the filter, the output voltage corresponding to the result of addition of the addition unit 217.

According to such a configuration, when the power converter 5 is provided to the power system 1 via the filter 3, deviation of the voltage actually outputted to the power system 1 can be suppressed by the filter 3. In other words, the voltage actually outputted to the power system 1 can be controlled to a desired value.

The power converter 5 of the first embodiment further includes: the voltage command value output unit 211 configured to output the voltage command value, based on the amplitude, the frequency, and the phase of the target voltage at the capacitor C; the calculation unit 213 configured to calculate the second current flowing through the capacitor C, based on the amplitude, the frequency, and the phase of the result of differentiation of the target voltage and the capacitance of the capacitor C; and the current command value output unit 214 configured to output the current command value of the first current, based on the target value of the second current and the measured value of the third current flowing from the node N, at which the reactor L and the capacitor C are connected, to the power system 1. According to such a configuration, it is possible to calculate the command value of the current of the reactor accurately, thereby being able to improve the accuracy of the voltage outputted to the power system 1.

The power converter 5 of the first embodiment further includes the amplitude calculation unit 210 configured to calculate the amplitude of the target voltage, based on the second difference between the target value of the amplitude of the target voltage and the amplitude of the voltage at the capacitor C. According to such a configuration, it is possible to calculate the voltage command value of the capacitor C accurately, thereby being able to further improve the accuracy of the voltage outputted to the power system 1.

Each of the power converters 6 and 7 of the second and third embodiments is a power converter that supplies power to the power system 1 via the filter 3 that includes the reactor L and the capacitor C, the power converter 6, 7 including: the subtraction unit 218 configured to calculate the difference between the voltage command value of the voltage at the capacitor C and the measured value of the voltage at the capacitor C; the current command value output unit 220 configured to output the current command value of the third current flowing through the reactor L for causing the voltage at the capacitor C to reach the target voltage, based on the target value of the first current flowing through the capacitor C when the voltage at the capacitor C reaches the voltage command value, the measured value of the second current flowing from the node N, at which the reactor L and the capacitor C are connected, to the power system 1, and the first value corresponding to the result of subtraction of the subtraction unit 218; the subtraction unit 215 configured to calculate the difference between the current command value and the measured value of the third current; the addition unit 217 configured to add the second value corresponding to the result of subtraction of the subtraction unit 215 and the measured value of the voltage at the capacitor C together; and the voltage output unit configured to output, to the filter 3, the output voltage corresponding to the result of addition of the addition unit 217.

According to such a configuration, when the power converter 6 or 7 is provided to the power system 1 via the filter 3, deviation of the voltage actually outputted to the power system 1 can be suppressed by the filter 3. In other words, the voltage actually outputted to the power system 1 can be controlled to the desired value.

The power converter 7 of the third embodiment further includes the restriction unit 221 configured to restrict the current command value outputted from the current command value output unit 220 within a predetermined range, and output a resultant to the subtraction unit 215. According to such a configuration, it is possible to prevent occurrence of an overcurrent.

Each of the power converter 6 and 7 of the second and third embodiments further includes: the voltage command value output unit 211 configured to output the voltage command value, based on the amplitude, the frequency, and the phase of the target voltage of the capacitor; and the calculation unit 213 configured to calculate the first current flowing through the capacitor, based on the amplitude, the frequency, and the phase of the result of differentiation of the target voltage and the capacitance of the capacitor. According to such a configuration, it is possible to calculate the command value of the current of the reactor L accurately, thereby being able to improve the accuracy of the voltage outputted to the power system 1.

Each of the power converters 6 and 7 of the second and third embodiments further includes: the output unit 219 configured to multiply the result of subtraction of the subtraction unit 218 by the reciprocal of the predetermined constant, to thereby output the first value; and the output unit 216 configured to multiply the result of subtraction of the subtraction unit 215 by the constant, to thereby output the second value. According to such a configuration, the power converters 6 and 7 are equivalent to the power converter of the first embodiment.

Each of the power converters 6 and 7 of the second and third embodiments further includes the amplitude calculation unit 210 configured to calculate the amplitude of the target voltage, based on the difference between the target value of the amplitude of the target voltage and the amplitude of the voltage at the capacitor C. According a to such configuration, it is possible to calculate the voltage command value of the capacitor C accurately, thereby being able to further improve the accuracy of the voltage outputted to the power system 1.

1. A power converter that supplies power to a power system via a filter that includes a reactor and a capacitor, the power converter comprising:
a processor, and
a non-transitory storage medium having program instructions stored thereon, execution of which by the processor causes the power converter to provide functions of:
a first subtraction unit configured to calculate a first difference between a measured value of a first current flowing through the reactor and a current command value of the first current for causing a voltage at the capacitor to reach a target voltage;
an addition unit configured to add a value corresponding to the first difference and a voltage command value of the voltage at the capacitor together; and
a voltage output unit configured to output, to the filter, an output voltage corresponding to a result of addition of the addition unit.

2. The power converter according to claim 1, wherein the execution of the program instructions by the processor causes the power converter to further provide functions of:
a voltage command value output unit configured to output the voltage command value, based on an amplitude, a frequency, and a phase of the target voltage of the capacitor;
a calculation unit configured to calculate a second current flowing through the capacitor, based on an amplitude, a frequency, and a phase of a result of differentiation of the target voltage and a capacitance of the capacitor; and
a current command value output unit configured to output the current command value of the first current, based on a target value of the second current and a measured value of a third current flowing from a node at which the reactor and the capacitor are connected, to the power system.

3. The power converter according to claim 1, wherein the execution of the program instructions by the processor causes the power converter to further provide functions of:
an amplitude calculation unit configured to calculate an amplitude of the target voltage, based on a second difference between a target value of the amplitude of the target voltage and an amplitude of the voltage at the capacitor.

4. A power converter that supplies power to a power system via a filter that includes a reactor and a capacitor, the power converter comprising:
a processor, and
a non-transitory storage medium having program instructions stored thereon, execution of which by the processor causes the power converter to provide functions of:
a first subtraction unit configured to calculate a difference between a voltage command value of a voltage at the capacitor and a measured value of the voltage at the capacitor;
a current command value output unit configured to output a current command value of a current flowing through the reactor for causing the voltage at the capacitor to reach a target voltage, based on
a target value of a first current flowing through the capacitor when the voltage at the capacitor reaches the voltage command value,
a measured value of a second current flowing from a node at which the reactor and the capacitor are connected, to the power system, and
a first value corresponding to a result of subtraction of the first subtraction unit;
a second subtraction unit configured to calculate a difference between the current command value and a measured value of the current flowing through the reactor;
an addition unit configured to add a second value corresponding to a result of subtraction of the second subtraction unit and the measured value of the voltage at the capacitor together; and
a voltage output unit configured to output, to the filter, an output voltage corresponding to a result of addition of the addition unit.

5. The power converter according to claim 4, wherein the execution of the program instructions by the processor causes the power converter to further provide functions of:
a restriction unit configured to restrict the current command value outputted from the current command value output unit within a predetermined range, and output a resultant to the second subtraction unit.

6. The power converter according to claim 5, wherein the execution of the program instructions by the processor causes the power converter to further provide functions of:
a voltage command value output unit configured to output the voltage command value, based on an amplitude, a frequency, and a phase of the target voltage of the capacitor; and
a calculation unit configured to calculate the first current flowing through the capacitor, based on an amplitude, a frequency, and a phase of a result of differentiation of the target voltage and a capacitance of the capacitor.

7. The power converter according to claim 6, wherein the execution of the program instructions by the processor causes the power converter to further provide functions of:
a first output unit configured to multiply a result of subtraction of the first subtraction unit by a reciprocal of a constant, to thereby output the first value; and
a second output unit configured to multiply a result of subtraction of the second subtraction unit by the constant, to thereby output the second value.

8. The power converter according to claim 4, wherein the execution of the program instructions by the processor causes the power converter to further provide functions of:
an amplitude calculation unit configured to calculate an amplitude of the target voltage, based on a difference between a target value of the amplitude of the target voltage and an amplitude of the voltage at the capacitor.
